(19) United States
(12) Patent Application Publication
(10) Pub. No.: US 2003/0216068 A1
(43) Pub. Date: Nov. 20, 2003

(54) Optically transparent elastomeric interconnects and method of using same

(76) Inventor: Roger E. Weiss, Foxborough, MA (US)

Correspondence Address: Brian M. Dingman, Esq., Mirick, O'Connell, DeMallie & Lougee, LLP, 1700 West Park Drive, Westborough, MA, 01581, US

(21) Appl. No.: 10/434,998

(22) Filed: May 10, 2003

Related U.S. Application Data
(60) Provisional application No. 60/380,587, filed on May 15, 2002.

(51) Int. Cl. H01R 4/58

(52) U.S. Cl. 439/91

(57) ABSTRACT

An optically transparent elastomeric electrical interconnect, the interconnect made from an optically transparent elastomeric material, with a number of conductive elements embedded in the elastomeric material and defining conductive pathways through the material.

### CROSS REFERENCE TO RELATED APPLICATION

This application claims priority of Provisional application serial No. 60/380,587, filed on May 15, 2002.

### FIELD OF THE INVENTION

This invention relates to an optically transparent elastomeric interconnect for electrical circuit elements.

### BACKGROUND OF THE INVENTION

Anisotropic Conductive Elastomer (ACE) is a composite of conductive metal elements in an elastomeric matrix. ACE is normally constructed such that it conducts along one axis only. In general, ACE is made to conduct through its thickness. In one reduction to practice, this anisotropic conductivity is accomplished by making the ACE as a sheet with conductive columns through the sheet thickness. This can be accomplished by mixing magnetic particles with a liquid resin, forming the mix into a sheet, and curing the sheet in the presence of a magnetic field with the filed lines running perpendicular to the sheet surfaces. This results in the particles forming electrically conductive columns along the filed lines, through the sheet thickness. The resulting structure has the unique property of being both flexible and anisotropically conductive. Such ACE thus has utility as a separable electrical interconnect between two electrical devices.

When interconnecting two or more circuit elements, it is quite common to use an optical pattern recognition system to register the position of the conductive elements prior to interconnecting them. This is especially true for high-density contacts such as those used on silicon wafers. In a typical application, the positions of the circuit elements on one circuit element, such as a circuit board, and the mating conductive elements on the other circuit element, are optically located. The location can be determined directly, or by the determination of the location of one or more fiducials that are designed to function as element locators. The interconnection medium is then carefully placed into the system, and the two circuit elements or components brought together. Any disruption of the position of either component resulting from the placement of the interconnection medium can result in a poor quality electrical connection between the components.

### SUMMARY OF THE INVENTION

This invention features an optically transparent elastomeric electrical interconnect, comprising an optically transparent elastomeric material, and a plurality of conductive elements embedded in the elastomeric material and defining conductive pathways through the material. The elastomeric material may comprise silicone. The conductive elements may comprise columns of conductive particles. The interconnect may comprise a sheet, with the columns passing through the sheet thickness. The conductive particles may be ferromagnetic, and formed into columns by magnetic alignment. The interconnect may be made by mixing the conductive particles with a liquid resin, and exposing the mixture to a magnetic field while the resin cures, so that the ferromagnetic particles form columns along the magnetic field lines, the columns held in placed by the cured elastomer.

This invention features in a more specific embodiment an optically transparent elastomeric electrical interconnect, comprising an optically transparent elastomeric material, and a plurality of conductive elements embedded in the elastomeric material and defining conductive pathways through the material, the conductive elements comprising columns of conductive, ferromagnetic particles, wherein the interconnect comprises a sheet, and the columns are magnetically aligned, and pass through the sheet thickness.

This invention also covers a method of interconnecting as least two electrical circuit elements having electrical contacts to be interconnected, using the optically transparent elastomeric electrical interconnect described above, the method comprising providing a first electrical circuit element having electrical contacts, placing on the electrical contacts of the first electrical circuit element, the optically transparent elastomeric electrical interconnect, providing a second electrical circuit element having electrical contacts to be electrically connected to the electrical contacts of the first electrical circuit element, aligning the electrical contacts of the first and second electrical circuit elements optically, including viewing the first electrical circuit element through the elastomeric electrical interconnect, contacting the aligned second electrical circuit element to the elastomeric electrical interconnect, and providing a compressive force to the first and second electrical circuit elements and the elastomeric electrical interconnect, to electrically interconnect the electrical contacts of the first and second electrical circuit elements through the elastomeric electrical interconnect.

### BRIEF DESCRIPTION OF THE DRAWINGS

Other objects, features and advantages will occur to those skilled in the art from the following description of the preferred embodiments, and the accompanying drawings in which:

FIG. 1 is an enlarged, schematic, cross-sectional view of an electrical circuit element interconnect created according to this invention; and

FIG. 2 is a partial top plan view of the partially-assembled electrical interconnect of FIG. 1.

### DETAILED DESCRIPTION OF THE PREFERRED EMBODIMENTS

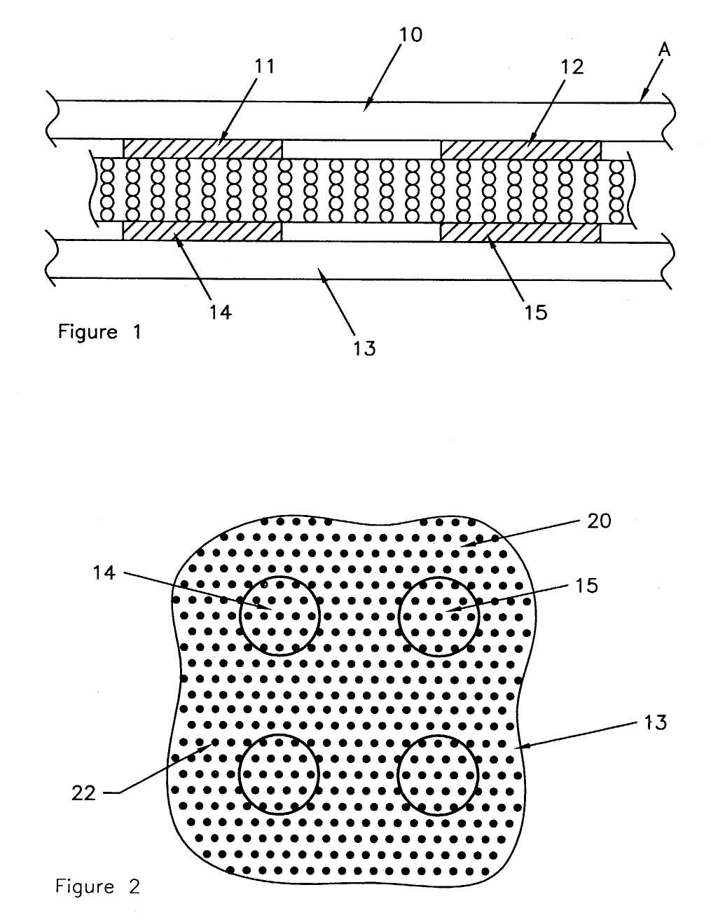

FIG. 1 is a cross sectional view of an ACE material interconnect of the invention having conductive columns defined by magnetically aligned, silver plated ferromagnetic nickel particles. Optically transparent ACE material interconnect 20 include the plurality of columns 22 of conductive particles passing through the thickness of the material. The columns run from one surface of the material to the other. Optically transparent elastomeric electrical interconnect 20 of this invention is used to electrically interconnect electrical contacts 14 and 15 of first electrical circuit element 13 to electrical contacts 11 and 12 of second electrical circuit element 10. Electrical contact is accomplished by providing a compressive force between elements 10 and 13 to create electrical paths along the conductive particle columns. Conductive particle ACE interconnects are known in the art.

According to the invention, by constructing ACE with a particle density that is under about 10%, by weight, of the total interconnect weight, and by using a highly transparent silicone material such as is known in the field of silicone materials, it is possible to form an optically transparent electrical interconnection medium.

When a layer of the inventive transparent ACE is placed on a field of one or more conducting elements, it is possible to view the conductors and any other features through the ACE. FIG. 2 shows the typical view that would be seen through transparent ACE of the invention. Optically transparent elastomeric electrical interconnect 20 includes a number of columns 22 of conductive particles. Since there are few conductive particles that are not in column form, the interconnect, when made of highly transparent elastomeric material, remains transparent, at least up to thickness of about 0.025 inches. The interconnect need only be adequately transparent so that the optical instrumentation such as a machine vision system being used for assembly of the connection can properly locate the necessary connector artifacts through the ACE. Accordingly, the maximum thickness of the ACE depends on variables such as the machine vision system being used, the nature of the elastomer used, and the size and quantity of conductors embedded in the elastomer. Typically, the ACE is sufficiently transparent such that the printed circuit board features are easily viewable with the naked eye.

With the interconnect 20 lying over contacts, such as contacts 14 and 15 of circuit element 13, such electrical contacts and/or fiducials on element 13 can be seen through the interconnect, thus allowing optical alignment systems to be used in creating the electrical interconnection between the two electrical circuit elements.

With the present invention, a transparent ACE interconnection medium is placed on one of the circuit elements prior to optical alignment. The optical alignment system then locates conductive elements or fiducials of the first circuit element through the transparent ACE. Once the other circuit element has been optically located, the system brings the elements into proper electrical contact, using the ACE as some or all of the interconnect between the electrical contacts of the two circuit elements. The likelihood of a quality electrical connection is thus increased.

What is claimed is:

1. An optically transparent elastomeric electrical interconnect, comprising:
an optically transparent elastomeric material; and
a plurality of conductive elements embedded in the elastomeric material and defining conductive pathways through the material.

2. The optically transparent elastomeric electrical interconnect of claim 1, wherein the elastomeric material comprises silicone.

3. The optically transparent elastomeric electrical interconnect of claim 1, wherein the conductive elements comprise columns of conductive particles.

4. The optically transparent elastomeric electrical interconnect of claim 3, wherein the interconnect comprises a sheet, and the columns pass through the sheet thickness.

5. The optically transparent elastomeric electrical interconnect of claim 3, wherein the conductive particles are ferromagnetic, and are formed into columns by magnetic alignment.

6. The optically transparent elastomeric electrical interconnect of claim 5, wherein the interconnect is made by mixing the conductive particles with a liquid resin, and exposing the mixture to a magnetic field while the resin cures, so that the ferromagnetic particles form columns along the magnetic field lines, the columns held in placed by the cured elastomer.

7. An optically transparent elastomeric electrical interconnect, comprising:
an optically transparent elastomeric material; and
a plurality of conductive elements embedded in the clastomeric material and defining conductive pathways through the material, the conductive elements comprising columns of conductive, ferromagnetic particles, wherein the interconnect comprises a sheet, and the columns are magnetically aligned, and pass through the sheet thickness.

8. A method of interconnecting as least two electrical circuit elements having electrical contacts to be interconnected, using the optically transparent elastomeric electrical interconnect of claim 1, the method comprising:
providing a first electrical circuit element having electrical contacts;
placing on the electrical contacts of the first electrical circuit element, the optically transparent elastomeric electrical interconnect of claim 1;
providing a second electrical circuit element having electrical contacts to be electrically connected to the electrical contacts of the first electrical circuit element;
aligning the electrical contacts of the first and second electrical circuit elements optically, including viewing the first electrical circuit element through the elastomeric electrical interconnect;
contacting the aligned second electrical circuit element to the elastomeric electrical interconnect; and
providing a compressive force to the first and second electrical circuit elements and the elastomeric electrical interconnect, to electrically interconnect the electrical contacts of the first and second electrical circuit elements through the elastomeric electrical interconnect.
